(19) United States
(12) Patent Application Publication
(10) Pub. No.: US 2014/0216605 A1
(43) Pub. Date: Aug. 7, 2014

(54) NEGATIVE RAKE SCRAPER

(71) Applicant: Stuart Batty, Boulder, CO (US)

(72) Inventor: Stuart Batty, Boulder, CO (US)

(21) Appl. No.: 14/085,771

(22) Filed: Nov. 20, 2013

Related U.S. Application Data
(63) Continuation-in-part of application No. 13/453,912, filed on Apr. 23, 2012.
Application No. 13/453,912 is a continuation-in-part of application No. 13/104,781, filed on May 10, 2011.
(60) Provisional application No. 61/728,762, filed on Nov. 20, 2012.
(60) Provisional application No. 61/478,349, filed on Apr. 22, 2011.

(51) Int. Cl. B27G 17/04; B23P 15/44

(52) U.S. Cl. CPC B27G 17/04; B23P 15/44
USPC 142/56; 76/119

(57) ABSTRACT

A negative rake scraper with a cutting blade and a cutting blade housing assembly that securely houses the cutting blade such that the blade can extend, retract, and be easily removed from the housing. The housing and the blade may have coplanar bottom and/or top surfaces providing reduced vibration and uninhibited movement of the tool across a tool rest. The cutting blade and housing may be removably attached to a vibration-dampening bolster that can be removably attached to handles of various dimensions.

### CROSS-REFERENCE TO RELATED APPLICATION

The document is a non-provisional patent application claiming priority to, and the benefit of, U.S. Provisional Patent Application Ser. No. 61/728,762, filed Nov. 20, 2012, also entitled “Negative Rake Scraper,” which is herein incorporated by reference in its entirety for all purposes. This document is also a continuation in part application claiming priority to, and the benefit of, U.S. patent application Ser. No. 13/104,781, filed May 10, 2011, entitled “Fluted woodturning tools with handles”; which is a non-provisional application claiming the benefit of Provisional Application No. 61/333,688, filed on May 11, 2010, by the same name; both of which are claimed priority to and herein incorporated by reference in their entirety for all purposes. This document is also a continuation in part application claiming priority to, and the benefit of, U.S. patent application Ser. No. 13/453,912, filed Apr. 23, 2012, entitled “Lathe Parting Tool”; which is a non-provisional application claiming the benefit of Provisional Application No. 61/478,349, filed on Apr. 22, 2011, by the same name; both of which are claimed priority to and herein incorporated by reference in their entirety for all purposes.

### BACKGROUND OF THE INVENTION

1. Field of the Invention

The present invention is in the technical field of woodturning tools. More particularly, embodiments of the present invention relate to woodturning tools of various kinds and types that are mounted into handles of varying lengths and are then used in a hand-held manner for the negative rake scraping of the stock or workpiece while that workpiece is being rotated on a lathe.

2. Description of Related Art

The following discussion will discuss negative rake scraping tools as a woodturning tool; however, this invention is not limited to use in the context of woodturning and may be used in metalworking, ceramics, or other trades. Negative rake scraping (using a negative rake scraper) is a technique that has been used since the 1500s for turning ivory, hardwoods, and dense exotic materials. Stuart Batty defined the rules on how, when, and where to use this technique, naming it “Negative Rake Scraping” to distinguish it from conventional scraping in the late 1990s. For negative rake scraping, it is essential that the scraper blade have a secondary ground angle on the top of the blade to be a negative rake: lifting or tilting a scraper does not make it a negative rake, only the secondary top angle does. The included angle of the ground bevels must be 70° or less to produce a satisfactory burr that a negative rake scraper requires. If there is no burr this technique becomes ineffective. It is the negative bevel combined with a burr that makes this technique so effective; hence, carbide cannot be used because it cannot create a burr.

Simply grinding the lower bevel on the scraper pushes some of the metal up on to the top bevel creating a burr. It should be produced with a coarse wheel or belt, not with a burnisher as a burnisher can curl the burr making it too aggressive. A sturdy grinding platform is strongly recommended so that you can create a burr at the same angle each time to get the longest life from your blade. The burr has a short life and will last approximately 90 seconds for each ½″ width of blade in contact when using CPM 10V® metal for the blade, M2 metal only lasts about 20 seconds. Though the burr life is short, it can be resharpened in less than 10 seconds and will dramatically improve surface shape and finish, allowing the turner to start with much finer grades of sand paper.

Negative Rake Scraping is a neutral technique. It neither draws the wood in like Conventional Scraping does, nor pushes it away as would a gouge. This makes it an exceptional technique for working very thin walled pieces or broken surfaces, like square bowls or natural edge. Negative Rake Scraping works best on medium density temperate woods and the densest exotic woods. It is also the very best tool on acrylics; plastics and acrylic impregnated woods because it will not grab at them. It can produce an unmatched finish on end grain or around the mixed grain surface of a side grain bowl. A Negative Rake Scraper can be used on either side; therefore when cutting at the very center of a box or bowl use caution not to cut past center. Negative Rake Scraping is never aggressive. It is slower at shaping than conventional scrapers, but it's a far more effective finishing technique because it removes the risk of grabbing at the wood. Negative Rake Scraping can easily smooth out long cuts by removing unwanted tool marks from gouges or torn grain from carbide scrapers.

All woodturners use woodturning tools. With few exceptions, these tools are very similar within families (such as, for example, Bowl Gouges, Spindle Gouges, Spindle Roughing Gouges, Detail Gouges, Negative Rake Scrapers and the like) for material selection and configuration. Thus there is no appreciable difference among sources for innate performance criteria. The few that utilize high performance materials are in limited supply and are considerably more expensive.

None of the currently available negative rake scraping tools incorporates any improvements in mechanical design that would effectively dampen vibration. None of the currently available negative rake scraping tools incorporates a manufacturing method that reduces the volume of expensive cutting edge material and thus reduces the overall material and manufacturing cost of the tool while maintaining its increased functionality. None of the currently available negative rake scraping tools uses a blade that is both reversible and can extend and retract. None of the currently available negative rake scraping tools incorporates a strengthening bolster for the tool shaft that includes a vibration damping material such as flake graphite cast iron. None of the currently available negative rake scraping tools incorporates a fiber, resin, and aluminum composite handle which reduces initial weight, damps vibration, reduces vibration transfer to the user of the tool, and allows the user to adjust handle weight to suit his preference. None of the currently available negative rake scraping tools incorporates a coplanar blade and housing which reduces vibration. None of the currently available negative rake scraping tools incorporates an easily replaceable or changeable handle, cutting blade, cutting blade assembly, and bolster.

### SUMMARY

The scope of the present invention is defined solely by the appended claims and detailed description of preferred embodiments, and is not affected to any degree by the statements within this summary.

According to embodiments of the present invention; a negative rake scraping tool assembly compromised of a multitude of pieces: a cutting blade housing assembly, a moveable and replaceable cutting blade, a stabilizing bolster, and a removable handle. The blade is secured in the housing forming the cutting blade assembly such that either the bottom of the housing and the bottom of the cutting blade are coplanar or the top of the housing and the top of the cutting blade are coplanar, or both the bottom and the top of the housing and the cutting blade are coplanar; thus providing uninhibited movement of the tool and reduction in vibration of the tool across the lathe tool rest as it enters a rotating workpiece.

The design of the housing and the cutting blade provide for easy blade replacement after completion of the blade's service life as well as the utilization of alternate blades for changing either the shape of the cutting blade, cutting widths, or the available range of cutting depths. The cutting blade may be comprised of an abrasion resistant material, which may comprise Vanadium, such as CPM 10V®.

The cutting blade assembly is secured in a reinforcing bolster that provides structural support and further dampens vibration from the cutting edge and reduces vibration transfer to the handle. The bolster also provides a means for removable attachment of the cutting blade assembly to handles of alternate diameters or lengths based on user preference. The bolster can be fitted into handles utilizing an internal threaded connection or some other connection mechanism. According to embodiments of the present invention, the bolster may be made of pearlitic matrix flake graphite cast iron thereby fortifying the strength of the tool, dampening vibration within the tool, and reducing vibration transfer to the handle of the tool.

Embodiments of this invention also comprise a method for manufacturing a negative rake scraping tool assembly by forming a cutting blade with multiple sides; forming a cutting blade housing assembly having multiple pieces with multiple sides wherein the cutting blade is housed; inserting the cutting blade into the cutting blade housing; securing the cutting blade in the cutting blade housing such that the cutting blade can be extended, retracted, and removed from the cutting blade housing; forming a handle; and removably attaching the cutting blade housing to the handle. The removable attachment of the cutting blade housing to the handle may comprise: forming a bolster; removably attaching the cutting blade housing to the bolster; removably attaching the bolster to the handle. Such bolster may be comprised of a vibration dampening material. The forming the cutting blade housing may also comprise forming a curved or asymmetrical distal end, such distal end possibly being tapered.

The method for manufacturing a negative rake scraping tool assembly defined in the prior paragraph, wherein the blade is secured in the housing forming the cutting blade assembly such that either the bottom of the housing and the bottom of the cutting blade are coplanar or the top of the housing and the top of the cutting blade are coplanar, or both the bottom and the top of the housing and the cutting blade are coplanar; thus providing uninhibited movement of the tool and reduction in vibration of the tool across the lathe tool rest as it enters the rotating workpiece.

While multiple embodiments are disclosed, still other embodiments of the present invention will become apparent to those skilled in the art from the following drawings, detailed description, and claims which show and describe illustrative embodiments of the invention. Accordingly, the drawings and detailed description are to be regarded as illustrative in nature and not restrictive.

### OBJECTS AND ADVANTAGES

The present disclosure can provide a number of advantages depending on the particular aspect, embodiment, and/or configuration. None of the particular objects or advantages that follow must be entirely satisfied as they are non-exclusive alternatives and at least one of the following objects is met; accordingly, several objects and advantages of the present invention are:
(a) to provide a replaceable cutting blade;
(b) to provide a replaceable cutting blade made in whole or in part of an abrasion resistant material, such as;
(c) to provide a replaceable cutting blade that may be made of an abrasion resistant material which may comprise Vanadium, such as CPM 10V®);
(d) to provide a housing for a cutting blade that securely holds the cutting blade, then inserting the blade into the cutting blade housing, wherein the blade may be extended, refracted, reversed, or fixed into place; thereby allowing for variable depth of cut, extending the useful life of the blade, and allowing the blade to be easily replaced;
(e) to provide a negative rake scraping tool with a cutting blade housing that does not have planar discontinuity with the bottom and/or top surfaces of a cutting blade allowing both the blade and the housing to slide smoothly across a tool rest, thereby reducing vibration and making the tool easier and more accurate to use;
(f) to provide a housing for a cutting blade that is made of a tough metal that is not brittle, such as iron;
(g) to provide a bolster that allows for quick replacement and accommodation of the proximal ends of cutting blades or cutting blade assemblies of various widths, depths, and lengths;
(h) to provide a handle that that allows for quick replacement of bolsters;
(i) to provide a method for manufacturing a negative rake scraping tool that may comprise the aforesaid objects and advantages.

These and other objectives and advantages of the instant invention will become apparent from the following description taken in conjunction with the accompanying drawings wherein are set forth, by way of illustration and example, certain embodiments of the instant invention. The drawings are intended to constitute a part of this specification and include exemplary embodiments of the present invention and illustrate various objects and features thereof.

### BRIEF DESCRIPTION OF THE DRAWINGS

### 1. Figures

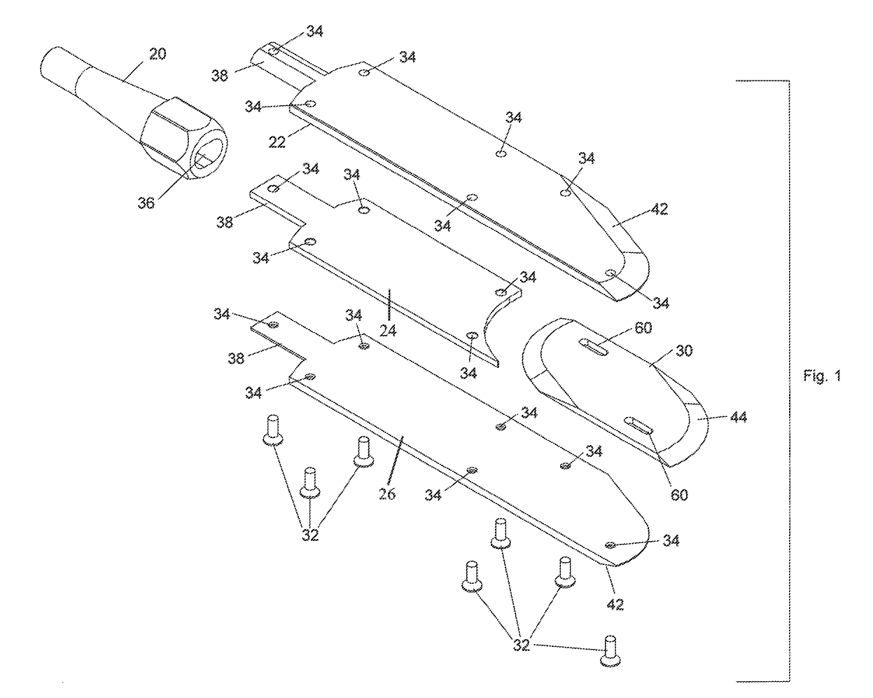

FIG. 1 (Sheet 1) illustrates an exploded perspective view of a negative rake scraping tool assembly, according to embodiments of the present invention.

FIG. 2 (Sheet 2) illustrates an exploded perspective view of a negative rake scraping tool assembly with a straight cutting blade, according to embodiments of the present invention.

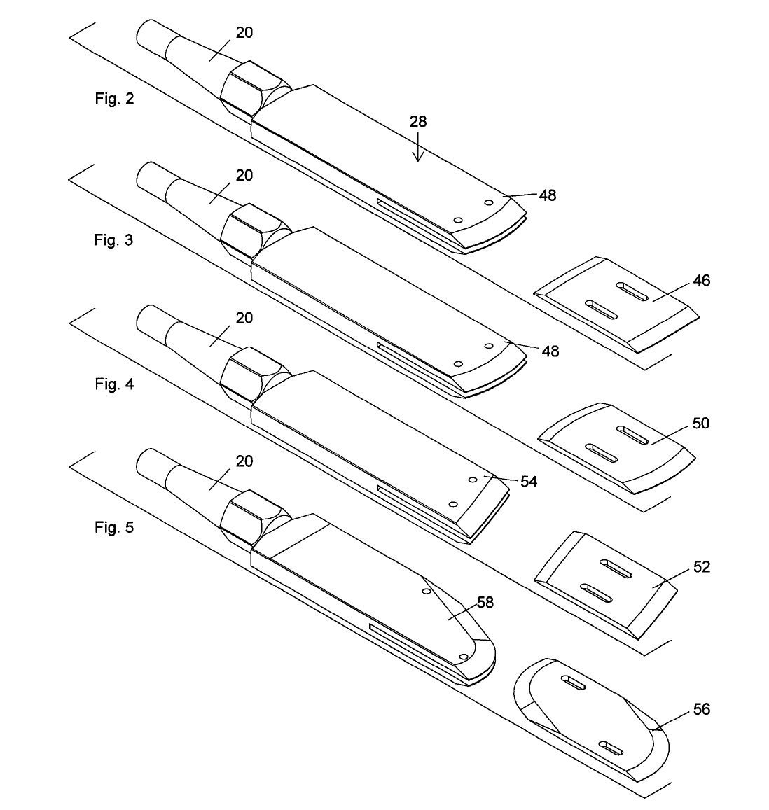

FIG. 3 (Sheet 2) illustrates an exploded perspective view of a negative rake scraping tool assembly with a domed cutting blade, according to embodiments of the present invention.

FIG. 4 (Sheet 2) illustrates an exploded perspective view of a negative rake scraping tool assembly with a skewed cutting blade, according to embodiments of the present invention.

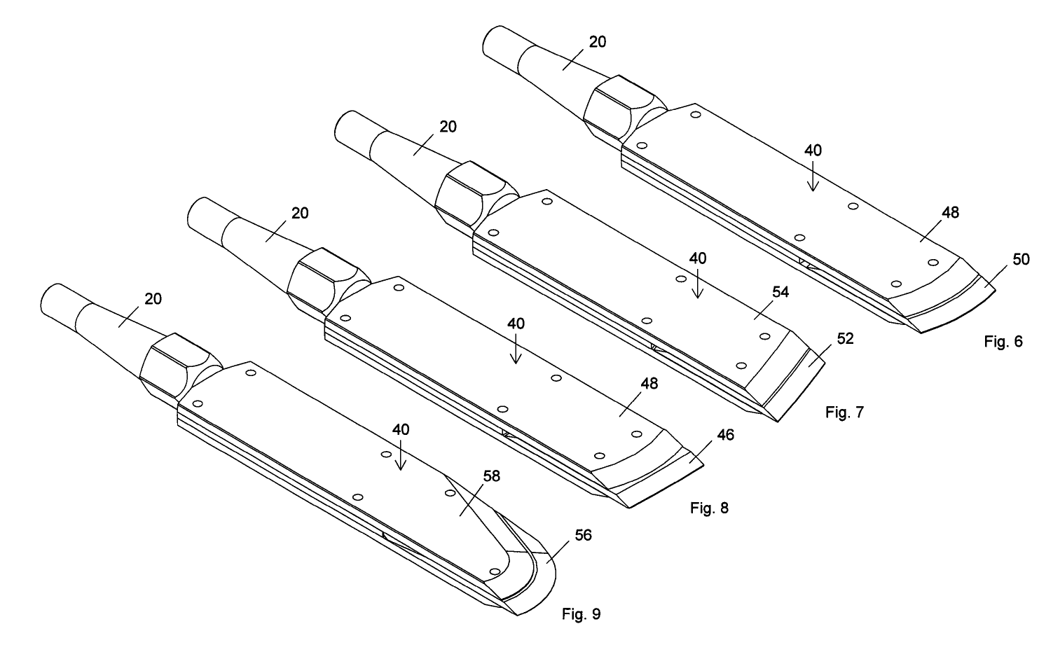

FIG. 5 (Sheet 2) illustrates an exploded perspective view of a negative rake scraping tool assembly with a swept cutting blade, according to embodiments of the present invention.

FIG. 6 (Sheet 3) illustrates a perspective view of a negative rake scraping tool assembly with a straight cutting blade, according to embodiments of the present invention.

FIG. 7 (Sheet 3) illustrates a perspective view of a negative rake scraping tool assembly with a domed cutting blade, according to embodiments of the present invention.

FIG. 8 (Sheet 3) illustrates a perspective view of a negative rake scraping tool assembly with a skewed cutting blade, according to embodiments of the present invention.

FIG. 9 (Sheet 3) illustrates a perspective view of a negative rake scraping tool assembly with a swept cutting blade, according to embodiments of the present invention.

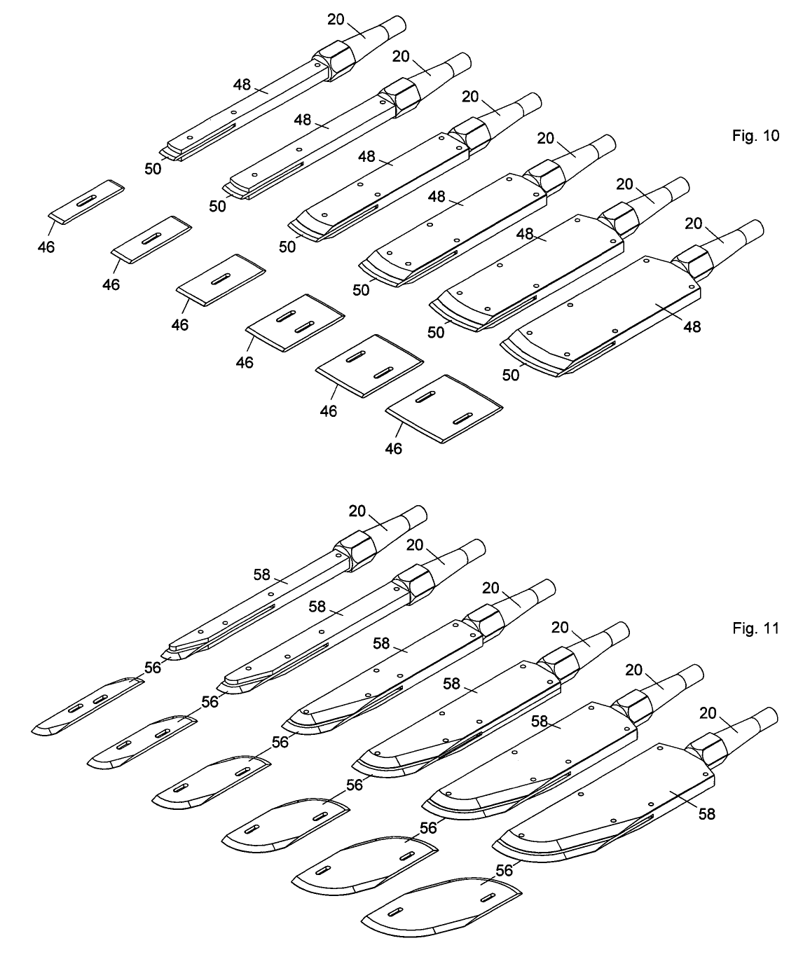

FIG. 10 (Sheet 4) illustrates a perspective view of a collection of straight and domed negative rake scrapers of varying widths, according to embodiments of the present invention.

FIG. 11 (Sheet 4) illustrates a perspective view of a collection of swept back negative rake scrapers of varying widths, according to embodiments of the present invention.

FIG. 12 (Sheet 5) illustrates a perspective view of a negative rake scraping tool assembly with a skewed cutting blade, according to embodiments of the present invention.

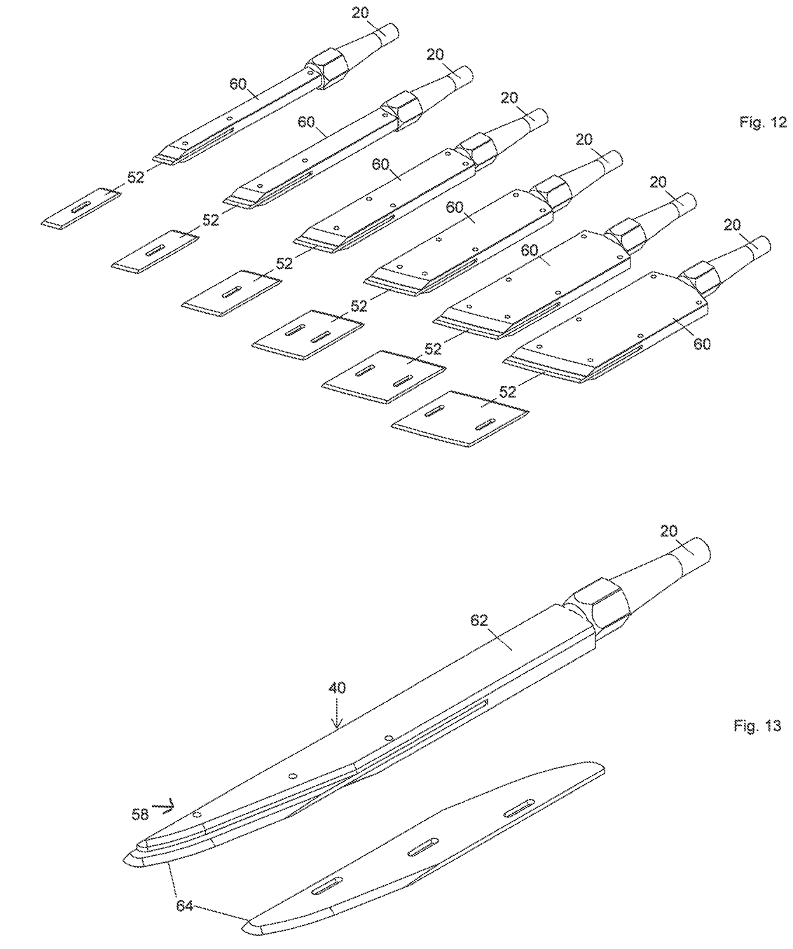

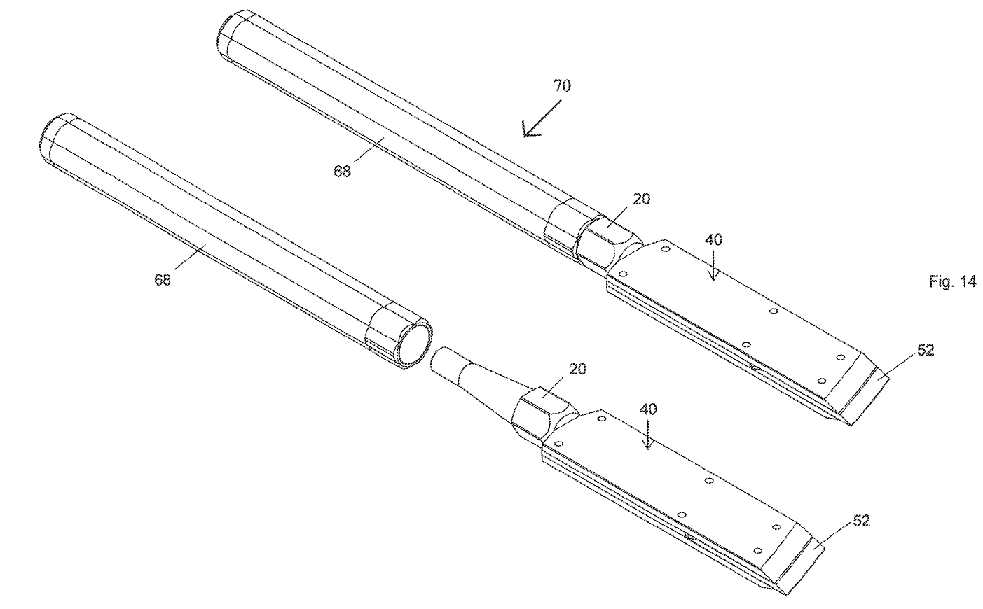

FIG. 13 (Sheet 5) illustrates a perspective view of a negative rake scraping tool assembly with a deep bowl swept cutting blade, according to embodiments of the present invention.

FIG. 14 (Sheet 6) illustrates a perspective view of a negative rake scraping tool assembly with an attached handle, according to embodiments of the present invention

### 2. References

20 A bolster
22 A top cutting blade housing section
24 A middle cutting blade housing section
26 A bottom cutting blade housing section
28 A cutting blade housing assembly
30 A cutting blade
32 Bolts
34 Cutting blade housing section holes
36 A bolster mortise
38 Proximal end of blade housing section adapted to be received by a bolster mortise
40 A negative rake scraping tool assembly
42 Tapered distal end of blade housing section
44 Angle of the cutting blade
46 A straight cutting blade
48 A cutting blade housing assembly with a curved and tapered distal end
50 A domed cutting blade
52 A skewed cutting blade
54 A cutting blade housing assembly with a flat and tapered distal end
56 A swept cutting blade
58 A cutting blade housing assembly with an swept and tapered distal end
60 A cutting blade housing assembly with a skewed and tapered distal end
62 A deep bowl cutting blade housing assembly with a swept and tapered distal end
64 A deep bowl swept cutting blade
66 A slot
68 A handle
70 A negative rake scraper

### DETAILED DESCRIPTION

### 1. Preamble

For the purposes of promoting an understanding of the principles of the present invention, reference will now be made to the embodiments illustrated in the drawings and specific language will be used to describe the same. However, the illustrated embodiments are merely exemplary and many additional embodiments of this invention are possible. For example, negative rake scrapers for woodworking are illustrated; however, this invention can be applied to negative rake scraper used on various materials. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

### 2. The Negative Rake Scraper

FIG. 1 illustrates an exploded perspective view of an embodiment of a negative rake scraping tool assembly. This embodiment of the negative rake scraping tool assembly comprises: a bolster (20); a top cutting blade housing section (22); a middle cutting blade housing section (24), a bottom cutting blade housing section (26), a cutting blade (30), bolts (32), and housing section holes (34). In other embodiments there could be only two cutting blade housing sections or more than three. When the housing sections are joined together they form a cutting blade housing assembly (28). When the cutting blade housing assembly (28) is joined with the cutting blade (30) and bolster (20) they form the negative rake scraping tool assembly (40).

Still referring to FIG. 1, the bolster (20) may have a mortise (36) for attachment of a cutting blade housing assembly (28). Additionally, the bolster (20) may provide structural support to the cutting blade housing assembly (28) by dampening vibration from the cutting blade and reducing the transfer of vibration to the handle (68) (see FIG. 14). The bolster (20) may be made of a vibration dampening material, such as a pearlitic matrix flake graphite cast iron, or any other suitable material known to dampen vibration in the art; thereby reducing vibration and making the tool easier and more accurate to use. The bolster (20) provides a means for removable attachment of alternate cutting blade housing assemblies (28) and handles (68) of alternate diameters or lengths based on user preference. The bolster (20) can be fitted into handles (68) utilizing an internal threaded connection (not pictured) or any other useful mechanism for attachment known to the art.

Still referring to FIG. 1; in the present embodiment; a top (22); middle (24), and bottom (26) cutting blade housing section can be attached to form a cutting blade housing assembly (28). Such means for attachment can be through the use of bolts (32) through holes (34) in the housing sections, which can be screws; or such attachment of the housing sections can be by any other known method for attachment of plates of metal known in the art. In another embodiment; the top (22), middle (24), and bottom (26) cutting blade housing sections can be milled from a single piece of metal; or the cutting blade housing sections can be brazed together to form the cutting blade housing assembly (28). Brazing the cutting blade housing sections into a singular cutting blade housing assembly (28) or milling the cutting blade housing assembly (28) from a single piece of metal will dampen the vibration of the negative rake scraping tool assembly (40) while in use and make replacement of the cutting blade (30) easier.

The cutting blade housing assembly (28) and/or cutting blade housing sections are preferably made out of a tough metal that is flexible, non-brittle, and unlikely to break. The proximal end of the blade housing sections (38) and cutting blade housing assembly (38) may be adapted to be received by a bolster mortise (36); while the tapered distal end (42) of the top (22) and bottom (26) housing sections or housing blade assembly (28) is adapted so that its angle may be coplanar, or nearly coplanar, with the angle of the tip of the cutting blade (44). The cutting blade housing sections or cutting blade housing assembly (28) and the cutting blade (30) can be made with a distal end that may be straight, curved, or asymmetrical. In other embodiments, alternate cutting blade housings assemblies (28) can be shaped to hold longer, taller, or wider cutting blades (30) and still fit the same bolster (20).

When the cutting blade housing assembly (28) is formed, the cutting blade (30) can be clamped into place at the distal end of the cutting blade housing assembly (28) with a nut (not pictured) and bolt (32); or by any other means for removably securing the cutting blade (30). The cutting blade (30) may be sharpened on two opposing sides and on two opposing ends. The cutting blade may be made by the method explained in U.S. patent application Ser. No. 13/104,781, filed May 10, 2011, entitled “Fluted woodturning tools with handles”; also invented by Stuart Batty; which is herein incorporated by reference in its entirety for all purposes.

The cutting blade (30) has slots (60) which run the length of the blade and allow for the blade to be held securely in the blade housing assembly (28) with the use of nuts and bolts or other removable means of attachment while also allowing the blade to be extended out of the blade housing assembly (28). This configuration allows for the extension of the cutting blade (30) to compensate for the frequent wear and sharpening of the cutting blade tip which is common when performing negative rake scraping, and the eventual reversal of the cutting blade to utilize the side of the cutting blade which still has a useful lifespan. Additionally, the cutting blade's usable lifespan can be increased by making the blade of a highly durable material such as 400-series stainless steel, or Vanadium. When both sides of the cutting blade (30) can no longer be extended beyond the cutting blade housing assembly (28) the cutting blade (30) may easily be replaced.

The cutting blade (30) can be manufactured by forming a blade of any one of various heights, widths, lengths, cutting edges, and materials by various means; including, but not limited to: milling, electrical discharge machining, extrusion, and/or grinding. The cutting blade can be heat treated to optimal woodturning properties before or after machining depending on the choices of material and assembly method. The cutting blade may be comprised of highly durable material, such as 400-series stainless steel, Vanadium, or any other durable material suitable for its purpose.

The cutting blade housing sections or cutting blade housing assembly (28) and the cutting blade (30) can be made to have coplanar bottom and/or top sides, thus providing uninhibited movement of the negative rake scraping tool assembly (40) across a tool rest as it enters a rotating workpiece. The coplanar nature of the cutting blade housing assembly (28) and cutting blade (30) also significantly increases the stability of the cutting blade (30) by maintaining it in a vertical plane, thereby allowing the user to make cleaner and more precise cuts. The coplanar bottom sides of the cutting blade assembly also give the cutting blade housing assembly (28) and cutting blade (30) a wider base, thereby significantly reducing vibration. These attributes of stability, uninhibited movement, and low vibration are particularly important for negative rake scraping tools because they are primarily used to put glassy smooth finishes on a piece of turned wood or other material.

When the cutting blade housing assembly (28) is inserted into a mortise (36) in a bolster (20) the negative rake scraping tool assembly (40) is formed. The bolster (20) can then be attached to a handle (68) with a threaded receptacle or any other method of removable or non-removable attachment known to the art.

Examples of embodiments of the negative rake scraping tool assembly (40) are as follows:

FIG. 2 illustrates an exploded perspective view of an embodiment of a cutting blade housing assembly with a curved and tapered distal end (48) attached to a bolster (20) and a detached straight cutting blade (46). FIG. 8 also illustrates this embodiment except with the straight cutting blade (46) attached to the cutting blade housing assembly (28) forming a negative rake scraping tool assembly (40).

FIG. 3 illustrates an exploded perspective view of an embodiment of a cutting blade housing assembly with a curved and tapered distal end (48) attached to a bolster (20) and a detached domed cutting blade (50). FIG. 6 also illustrates this embodiment except with the domed cutting blade (50) attached to the cutting blade housing assembly (28) forming a negative rake scraping tool assembly (40).

FIG. 4 illustrates an exploded perspective view of an embodiment of a cutting blade housing assembly with a skewed and tapered distal end (54) attached to a bolster (20) and a detached skewed cutting blade (52). FIG. 7 also illustrates this embodiment except with the skewed cutting blade (52) attached to the cutting blade housing assembly (28) forming a negative rake scraping tool assembly (40).

FIG. 5 illustrates an exploded perspective view of an embodiment of a cutting blade housing assembly with a swept and tapered distal end (58) attached to a bolster (20) and a detached swept cutting blade (56). FIG. 9 also illustrates this embodiment except with the swept cutting blade (56) attached to the cutting blade housing assembly (28) forming a negative rake scraping tool assembly (40).

FIG. 10 illustrates a perspective view of a collection of embodiments of cutting blade housing assemblies with curved and tapered distal ends (48) attached to bolsters (20) and domed cutting blades (50) forming a collection of negative rake scraping tool assemblies (40) of various sizes; and a collection of detached straight cutting blades (46) that could also be used.

FIG. 11 illustrates a perspective view of a collection of embodiments of cutting blade housing assemblies with swept and tapered distal ends (58) attached to bolsters (20) and swept cutting blades (56) forming a collection of negative rake scraping tool assemblies (40) of various sizes; and a collection of detached swept cutting blades (56).

FIG. 12 illustrates a perspective view of a collection of an embodiment of cutting blade housing assemblies with skewed and tapered distal ends (60) attached to bolsters (20) and skewed cutting blades (52) forming a collection of negative rake scraping tool assemblies (40) of various sizes; and a collection of detached skewed cutting blades (52).

FIG. 13 illustrates a perspective view of an embodiment of a deep bowl swept cutting blade housing assembly (62) with a swept and tapered distal end (58) attached to a bolster (20) and an attached and detached deep bowl swept cutting blade (64).

FIG. 14 illustrates a perspective view of an embodiment of a negative rake scraping tool assembly (40) attached to a handle (68) forming a negative rake scraper (70). The handle may that of U.S. patent application Ser. No. 13/104,781, filed May 10, 2011, entitled “Fluted woodturning tools with handles”; also invented by Stuart Batty; which is herein incorporated by reference in its entirety for all purposes.

### 3. Conclusion

It is to be understood that while certain forms of the invention are illustrated, it is not to be limited to the specific forms or arrangements herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments; are intended to be exemplary; and are not intended as limitations on the scope. Changes therein and other uses will occur to those skilled in the art which are encompassed within the spirit of the invention and are defined by the scope of the claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

1. A negative rake scraper comprising:
a cutting blade;
a cutting blade housing wherein said cutting blade is removably attached;
a handle.

2. The negative rake scraper of claim 1, further comprising a bolster.

3. The negative rake scraper of claim 2, wherein said cutting blade housing can be removably attached to said bolster.

4. The negative rake scraper of claim 2, wherein said bolster can be removably attached to said handle.

5. The negative rake scraper of claim 2, wherein said bolster can be removably attached to said handle and said cutting blade housing.

6. The negative rake scraper of claim 1, wherein said cutting blade housing is comprised of more than one piece removably attached together.

7. The negative rake scraper of claim 1, wherein said cutting blade is sharpened on at least two opposing sides on two opposing ends.

8. The negative rake scraper of claim 1, wherein said cutting blade is capable of sliding forward and backward in said cutting blade housing.

9. The negative rake scraper of claim 1, wherein said cutting blade housing has a tapered distal end.

10. The negative rake scraper of claim 9, wherein said cutting blade housing has a tapered distal end that is roughly coplanar with two sides of the tip of said cutting blade.

11. The negative rake scraper of claim 1, wherein said cutting blade and said cutting blade housing share a flat coplanar side.

12. The negative rake scraper of claim 1, wherein said cutting blade and said cutting blade housing share two flat coplanar sides.

13. The negative rake scraper of claim 1, wherein said cutting blade and said cutting blade housing share two flat coplanar sides with the cutting blade and two roughly coplanar sides with the tip of the cutting blade.

14. The negative rake scraper of claim 1, wherein said cutting blade housing has a curved distal end.

15. The negative rake scraper of claim 1, wherein said cutting blade housing has a skewed distal end.

16. A method for manufacturing negative rake scraper, comprising:
forming a cutting blade with multiple sides;
forming a cutting blade housing having multiple sides, wherein the cutting blade is housed;
removably attaching the cutting blade to the cutting blade housing;
securing the cutting blade in the cutting blade housing such that the cutting blade can be extended, retracted, and removed from the cutting blade housing;
forming a handle; and
removably attaching the cutting blade housing to the handle.

17. The method of claim 16, wherein the removable attachment of the cutting blade housing to the handle comprises:
forming a bolster;
removably attaching the cutting blade housing to the bolster;
removably attaching the bolster to the handle.

18. The method of claim 16, wherein one or more sides of the cutting blade housing is formed to be coplanar with the cutting blade.

19. The method of claim 16, wherein forming the cutting blade housing comprises forming a tapered distal end.

20. The method of claim 16, wherein said cutting blade housing is formed with a distal end that is tapered and roughly coplanar with the sides of the tip of said cutting blade.
